(19) United States
(12) Patent Application Publication
(10) Pub. No.: US 2015/0231507 A1
(43) Pub. Date: Aug. 20, 2015

(54) FANTASY SPORTS SYSTEM

(71) Applicant: Michael Vu, Sunnyvale, CA (US)

(72) Inventor: Michael Vu, Sunnyvale, CA (US)

(21) Appl. No.: 14/184,494

(22) Filed: Feb. 19, 2014

(51) Int. Cl. A63F 13/828

(52) U.S. Cl. CPC A63F 13/828

(57) ABSTRACT

A fantasy sports system, including a fantasy sports web site hosted by a fantasy sports server. A user may access the fantasy sports web site, over a network, to register a team to compete in a fantasy sports league. The user manages his/her team to compete against one or more other user-managed teams and at least one server-managed team in a fantasy sports league. The fantasy sports server may manage all aspects (e.g., drafting strategy, daily line-up setting strategy, add/drop strategy, etc.) of each server-managed team to compete against the user-managed teams and the other server-managed teams. For each league, the teams may compete against each other for a period of time (e.g., a full sports season or a partial sports season) to determine a winner of each league.

### FIELD OF THE INVENTION

The present invention relates to online fantasy sports games.

### BACKGROUND

Millions of people in the United States and abroad participate in fantasy sports leagues every year. Although fantasy sports have been around since the 1960s, the hobby's popularity exponentially increased in the 1990s during the internet boom and continues to grow every year. The fantasy sports phenomenon has undoubtedly changed the way sports are reported, viewed, and advertised. For example, several of the most popular sports television shows now incorporate fantasy sports updates and segments into their programming schedule. Moreover, with the advent of mobile technology, such as smart-phones and tablets, users can receive instant updates on how their fantasy sports teams are performing.

A fantasy sports league is an interactive competition amongst users that manage “fantasy teams” in the league. In an internet fantasy sports league, each user accesses a web site provided by a fantasy sports provider to participate in the fantasy sports league against other users. Each participant in a given league, sequentially with the other participants in that league, drafts a group of real-world athletes who are in an actual professional or amateur sports league, to form a fantasy roster of players for that participant's respective fantasy team. Each drafted athlete's real-world performance statistics translate to points earned for the fantasy league team to which the athlete was drafted or later traded or obtained off of waivers. The fantasy league teams compete against each other based on a variety of scoring rules, and a league champion emerges.

Most fantasy leagues are comprised of at least eight different teams. Finding seven other people interested in joining a fantasy league can be difficult. For example, some fantasy users only want to play against friends or other fantasy users at substantially their own level of experience and skill. Finding enough friends or users with similar fantasy experience and skill to create a league may be difficult.

However, fantasy leagues which allow only a single fantasy user to play against a league of computer teams also have disadvantages such as user engagement and interaction. It is not uncommon for single player games, such as those offered by in-home gaming consoles and mobile applications to allow the user to post his or her score on social media to allow users to interact, engage and compete with each other. Therefore, being able to offer a full and complete fantasy league with more than one user, but less than enough users to fill the league is desirable.

Some users lose interest if their teams are not doing well or if they are too busy. In such circumstances, the user who lost interest may stop managing his or her team and thus other users playing against that team, such as in head-to-head leagues, may have a greatly increased chance of beating that team. This can be unfair to other users who played that team when the user still had interest, perhaps resulting in a loss to that team, or users who are competing with the user currently playing that team, for a playoff spot or to win the league. Further, the league may lose its competitive nature and none of the users may be motivated to pay attention to their respective teams. Therefore, there is a need to be able to replace management of team that is no longer being managed by a user with a computer that can maintain the competitiveness of the team and league.

Fantasy leagues are known which allow only a single fantasy user to play against a league of computer teams. There are also fantasy league providers that allow mock or fake drafts wherein a single fantasy user or multiple fantasy users draft against the computer. Such mock drafts allow fantasy users to better understand how select players are being valued and where select players are being drafted so that they can apply the information learned during the mock draft(s) during the user's actual draft for the league in which he or she will compete. The teams created during the mock draft are temporary such that after the completion of a mock draft the teams are not entered into a competition, they are deleted, and the user is free to draft another mock team.

The invention relates to improvements to the systems described above, and to solutions to some of the problems raised or not solved thereby.

### SUMMARY OF THE INVENTION

The invention includes a computer system, which has a data storage medium for storing information thereon. A database is stored on the data storage medium, the database including data structures representing a plurality of players in a sports league and corresponding statistics and management data for each player, a plurality of computer- and subscriber-managed fantasy sports teams and corresponding roster and attribute data for each of the fantasy sports teams; and a plurality of fantasy sports leagues, each league comprising a plurality of fantasy sports teams, at least one of the fantasy sports teams being a computer-managed fantasy sports team and at least two other fantasy sports teams being subscriber-managed fantasy sports teams. The computer system of the invention further includes a processor, a league operation software application to operate the processor so as to operate the fantasy sports leagues; and a computer team manager software application. The computer team manager software application drafts players for the computer-managed fantasy sports teams among the fantasy sports leagues according to the statistics and management data, manages the computer-managed sports teams within the fantasy sports leagues according to the statistics and management data, and competes with the subscriber-managed fantasy sports teams according to rules in the respective leagues. The statistics data includes past and present performance data on the players, which is used to project future performance of the players. The management data includes an add/drop indicator, a start/bench indicator, and/or an overall ranking for each player. The computer team manager software application sends drafting and management commands to the processor according to the statistics and management data. The computer team manager program can be manually overridden by an administrator to manually send management commands to the processor. The computer team manager program is configured to determine the drafting commands according to a drafting manager based on the statistics data and management data, and determine the management commands according to an add/drop manager and a line-up manager, which are based on the statistics data and management data.

Another aspect of the invention is a fantasy sports system, which includes a data structure representing at least one fantasy sports league comprising links to data representing a set of at least one computer-managed team and at least two user-managed teams, each computer-managed team and each user-managed team comprising a roster of real-world athletes in a sports league. A server controls the computer-managed teams to draft athletes and manage the respective rosters of the computer-managed based on statistics and management data associated with each real-world athlete. The statistics data include past and present performance data, which is used to project future performance of the athletes. The management data includes an add/drop indicator, a start/bench indicator, and/or an overall ranking for each athlete. The server can be manually overridden by an administrator to manually control the computer-managed teams. The server is configured to draft athletes according to a drafting manager based on the statistics data and management data, and manage the computer-managed teams according to an add/drop manager and a line-up manager, which are based on the statistics data and management data. The drafting application drafts balanced rosters for the computer-managed teams. The managing application sets a line-up for each computer-managed team based on an overall ranking for each athlete on the respective computer-managed team.

Another aspect of the invention is a fantasy sports server, which includes a data storage medium for storing information therein, and a processor. A database is stored in the data storage medium, the database including data structures representing a plurality of players in a sports league and corresponding statistics and management data for each player, a plurality of computer- and subscriber-managed fantasy sports teams and corresponding roster and attribute data for each team, and a plurality of fantasy sports leagues, each league comprising a plurality of fantasy sports teams, at least one team being a computer-managed team and at least two other teams being subscriber-managed teams. The server also has a computer team manager program to transmit drafting and management commands according to the statistics and management data, and manage the computer-managed fantasy sports teams to compete against the subscriber-managed fantasy sports teams in response to the drafting and management commands. A league operation software application receives the drafting and management commands from the computer team manager program and from subscribers, modifies data in the database to maintain rosters and related information, and operates the processor so as to operate the fantasy sports leagues. The statistics data includes past and present performance data, to be used for projecting future performance. The management data includes an add/drop indicator, a start/bench indicator, and/or an overall ranking for each player. The computer team manager program can be manually overridden by an administrator to manually send management commands to the processor. The computer team manager program is configured to determine the drafting commands according to a drafting manager based on the statistics data and management data, and determine the management commands according to a add/drop manager and a line-up manager, which are based on the statistics data and management data. The drafting application drafts balanced rosters for the computer-managed teams. The team managing application sets a line-up for each computer-managed team based on an overall ranking for each player on the respective computer-managed team's roster.

The invention further provides a method of operating a fantasy sports server, which server includes a processor and a data storage medium. The method includes storing a database in the data storage medium, the database including data structures representing a plurality of players in a sports league and corresponding statistics and management data for each player; a plurality of computer- and subscriber-managed fantasy sports teams and corresponding roster and attribute data for each team; and a plurality of fantasy sports leagues, each league having a plurality of fantasy sports teams, at least one team being a computer-managed team and at least two other teams being subscriber-managed teams. The method also includes a computer team manager software application for transmitting drafting and management commands according to the statistics and management data and managing the computer-managed fantasy sports teams to compete against the subscriber-managed fantasy sports teams in response to the drafting and management commands, and a league operation software application to receive the drafting and management commands from the computer team manager program and from subscribers, modifying data in the database to maintain rosters and related information, and operating the processor so as to operate the fantasy sports leagues. The statistics data includes past and present performance data, and is used to project future performance. The method further includes providing an add/drop indicator, a start/bench indicator, or an overall ranking for each player. The computer team manager program can be manually overridden to manually send management commands to the processor. The computer team manager program can be configured to determine the drafting commands according to a drafting manager based on the statistics data and management data, and determine the management commands according to a add/drop manager and a line-up manager, which are based on the statistics data and management data. The method also has the capability to draft balanced rosters for the computer-managed teams, as well as setting a line-up for each computer-managed team based on an overall ranking for each player on the respective computer-managed team's roster.

Another aspect of the invention is a fantasy sports system with a plurality of user teams forming a fantasy league with rules. Each of the plurality of user teams contains a roster having a subset of players from the set of players in a sports league. A computer team manager software application is used to manage one of the plurality of user teams by operating the processor to determine a line-up of select players from the managed one of the plurality of user teams roster, remove players from the managed one of the plurality of user teams roster and add new players from the set of players in a sports league not then on the roster of any of the plurality of user teams, modify projected future performance of each of the set of players in a sports league, and compete the managed one of the plurality of user teams against the other of the plurality of user teams according to the rules in the fantasy league.

Other objects and advantages of the invention will become apparent hereinafter.

### BRIEF DESCRIPTION OF THE DRAWINGS

FIG. 1 is a block diagram of a fantasy sports system according to an embodiment of the present invention.

FIG. 2 is a detailed block diagram of a fantasy sports server database according to embodiments of the present invention.

FIG. 3 is a detailed block diagram of a fantasy sports computer team manager program according to embodiments of the present invention.

FIG. 4 is a screenshot of a player rankings manager web page according to embodiments of the present invention.

FIG. 5 is a screenshot of a web page containing historical player rankings data according to embodiments of the present invention.

FIG. 6 is a screenshot of an add/drop manager web page according to embodiments of the present invention.

FIG. 7 is a screenshot of a line-up manager web page according to embodiments of the present invention.

FIG. 8 is a screenshot of a manual override web page according to embodiments of the present invention.

### DETAILED DESCRIPTION

The present invention provides a fantasy sports system, which will generally includes a fantasy sports web site hosted by a fantasy sports server. The web site will include one or more graphical user interfaces (GUIs) to enable users to interact with the web site to compete in one or more fantasy sports leagues hosted by the server. Initially, a user may access the fantasy sports web site over a network, to register one or more teams to compete in one or more fantasy sports leagues. According to the invention, the user manages his/her team to compete against one or more other user-managed teams and at least one server-managed team in a fantasy sports league during the course of a fantasy sports season based on a given real-world sport with real-world athletes or players or fictitious players from a fictitious sport. Advantageously, the fantasy sports server has the ability to globally manage all aspects (e.g., drafting strategy, daily line-up setting strategy, add/drop strategy, etc.) of each server-managed team to compete against the user teams and any other server-managed teams. For each league, the teams (both user and server) compete against each other for a period of time (e.g., a full sports season, a partial sports season, a week, a day, an hour, or any period of time or game play) to determine a winner of each league. According to some embodiments of the present invention, the users in different leagues may also compete against each other to determine which user is performing the best across the various fantasy sports leagues in the system.

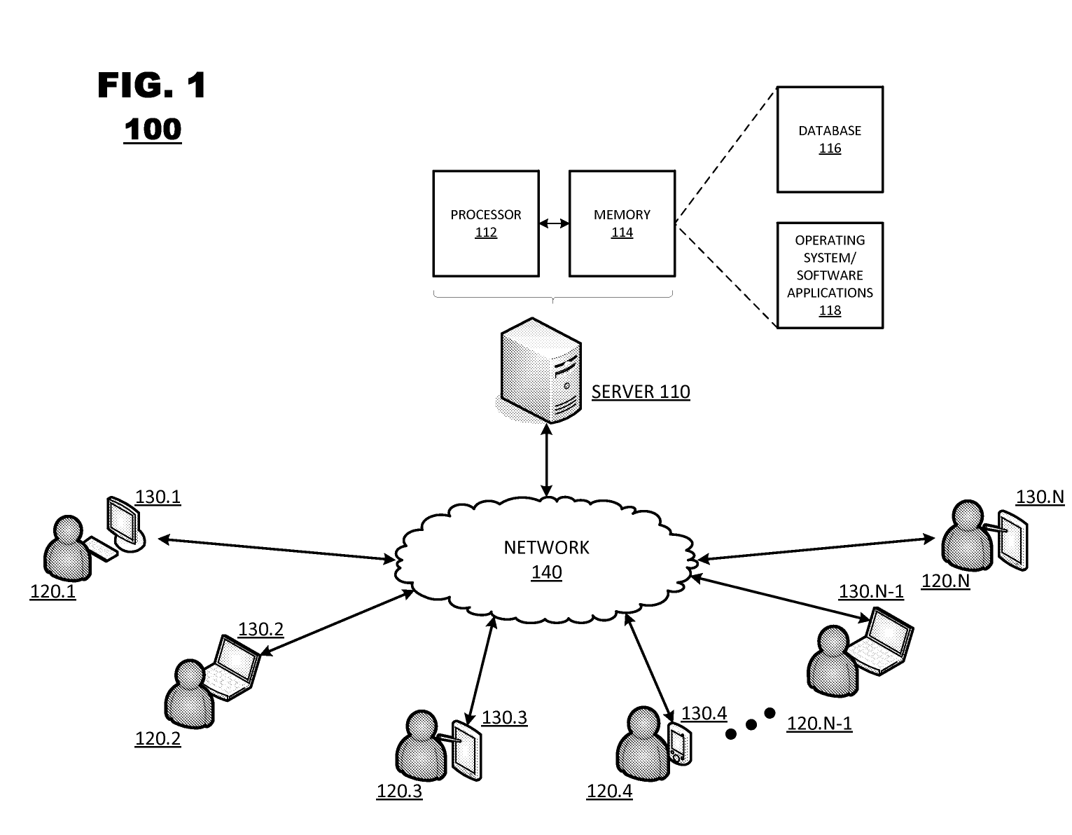

FIG. 1 is a block diagram of a fantasy sports system 100 according to an embodiment of the present invention. The fantasy sports system 100 may be based on any real-world-sports league, such as the National Football League, the English Premier League, Major League Baseball, National Basketball Association, etc., or fictitious sport leagues. For ease of discussion, the system 100 is described herein based on an embodiment that uses the National Basketball Association (NBA) as the basis for gameplay, but the invention is not to be taken as limited to any one sport or game.

The fantasy sports system 100 hosts a web site that may provide a plurality of fantasy sports leagues in which users can compete. The web site includes one or more graphical user interfaces (GUIs) to enable users to interact with the web site to compete in one or more fantasy sports leagues provided by the server. The present system 100 implements various types of leagues, such as head-to-head leagues, rotisserie leagues, or other types of fantasy sports leagues.

The system 100 shown in FIG. 1 includes a server 110, a plurality of subscribers 120.1-120.N, and a network 140. As shown there, the subscribers (or users) 120.1-120.N use corresponding devices 130.1-130.N to access the fantasy sports web site, over the network 140, located at the fantasy sports server 110 to participate in fantasy sports leagues provided on the web site. Each fantasy sports league hosted by the server 110 includes at least two subscriber- or user-managed teams and at least one server- or computer-managed team. Each user acts as “manager” of his or her individual team and competes with the other users and the server-managed teams in a given league during the course of a sports season. An individual user may manage multiple teams in multiple leagues, if desired.

The network 140 may include any number of local area networks (LANs), wireless local area networks (WLANs), wide area networks (WANs) and the Internet to facilitate communication between the server 110 and the user devices 130.1-130.N. The network 140 allows users to interact with an interactive fantasy sports web site hosted by the server 110 to register for a fantasy sports league, draft fantasy sports teams, manage their fantasy sports teams, and monitor the performance of their teams throughout the course of a sports season. The configuration of the network 140 is immaterial to the present discussion unless described hereinbelow.

The devices 130.1-130.N may include various different types of devices that allow users 120.1-120.N to access a web site provided by the server 110. The devices 130.1-130.N may include, but are not limited to, desktop computers (130.1 for example), laptop computers (130.2 for example), tablets (130.3 for example), smart phones (130.4 for example), and other devices that are capable of accessing a web site over the network 140 to allow the users 120.1-120.N to participate in fantasy sports league(s) hosted by the server 110. For example, a given user (120.1 or 120.2) may operate a desktop (130.1 for example) or laptop (130.2 for example) computer to use the internet and navigate to the fantasy sports web site by using a web browser. Some users (120.3 or 120.4) may download and access a mobile application to access the fantasy sports content on their mobile tablet (130.3 for example) or smart phone (130.4 for example).

As described above, the fantasy sports server 110 may host a fantasy sports web site with a plurality of fantasy sports leagues in which users can compete. The server 110 will generally include various sub-components such as a processor 112 and a memory 114. The processor 112 may be provided in various configurations, such as a central processing unit (“CPU”), a field-programmable gate array (“FPGA”), an application specific integrated circuit (“ASIC”), or any other suitable logic device or combination of logic devices.

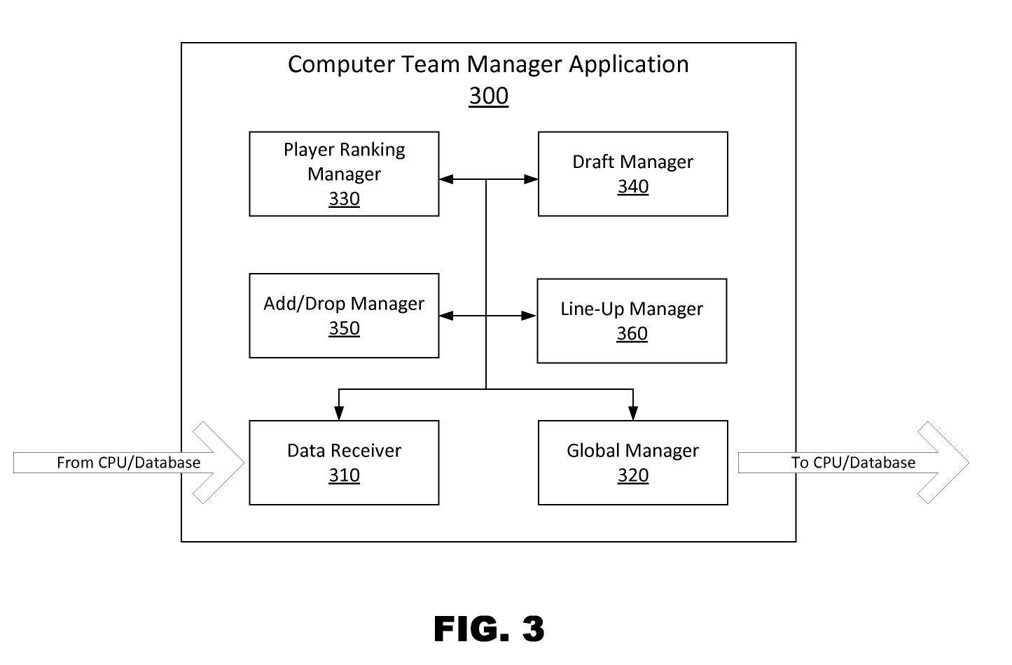

The memory 114 will generally include a machine readable medium including volatile memory (such as DRAM, SRAM, or the like) and non-volatile memory (such as ROM, RLASH, EEPROM, solid state hard drives, conventional spinning platter hard drives, and so on). The memory 114 may store processor-executable instructions (i.e., software programs such as operating system software and other software applications used to run the fantasy sports web site) 118 and a database 116 which may be modified and/or accessed by the processor 112. According to the invention, the software applications will generally include a team manager software application (described in further detail below with respect to FIG. 3) used to control the computer teams competing on the fantasy sports web site. There may be other types of software applications, such as those described below, stored in the memory as desired by the server administrators.

According to the invention, the database 116 holds information related to the fantasy sports leagues, fantasy sports teams, and rules for each league associated with the fantasy sports web site. The database 116 may also contain player performance data. The structure and contents of the database 116 will be described in further detail below.

The processor 112 may access and execute the operating system software and the software applications 118 stored at the memory 114 to facilitate the general operation of the server 110, such as managing data stored in the database 116, parsing HyperText Markup Language (HTML) code and transmitting resulting information and images to the devices 130.1-130.N of users 120.1-120.N so the users may access the fantasy sports web site, verifying user 120.1-120.N credentials, updating the database based on new player statistics and decisions made by users, etc. The processor 112 may also access data stored in the database 116 and provide the data to the users 120.1-120.N (in the form of data displayed on the fantasy sports web site). The software applications 118 will also include a league operation software application (or program) to control operation of the fantasy sports leagues, including some or all of: scheduling and conducting the games between the various fantasy sports teams within a fantasy sports league; keeping score and determine winners and losers of individual games; and maintaining leaderboards, possibly including and not necessarily limited to league-only leaderboards and global leaderboards, based upon the scores and/or the win/loss records of individual fantasy sports teams. For example, software applications 118 may include a scoring means for assigning values to each player from the line-up of players based upon the performance of the players from the line-up of players and the scoring parameters and for determining the relative performance of the two user teams and at least one computer team with respect to each other. The league operation software application (or program) also receives input from users or subscribes relating to drafting and management of the user-managed fantasy teams and transmits drafting and management commands to the processor.

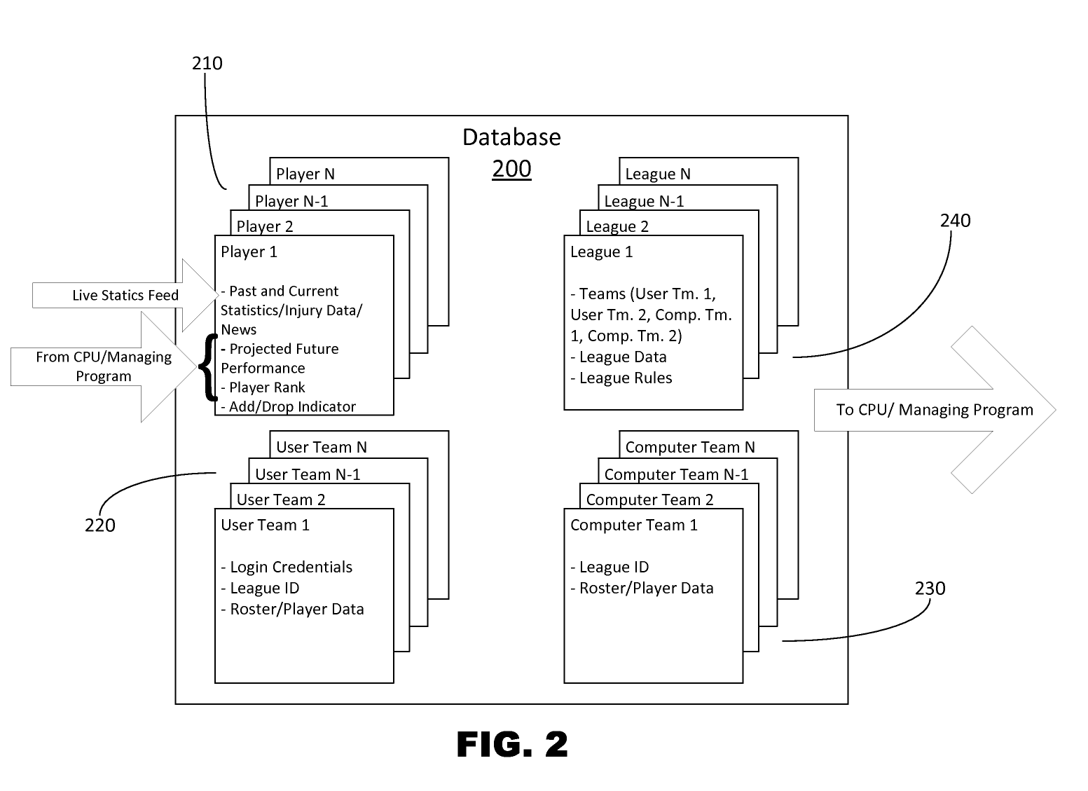

FIG. 2 is a detailed block diagram of an example of a database 200 that may be implemented in the fantasy sports system 100 of FIG. 1 according to an embodiment of the present invention. The database 200 may contain data structures 210-240 representing a plurality of real-world players (or athletes) 1-N in the NBA (or other real-world sports league), a plurality of user-managed fantasy teams 1-N, a plurality of server-managed fantasy teams 1-N, and a plurality of fantasy leagues 1-N, respectively, formed of the fantasy teams just identified. The foregoing data structures are all interrelated (i.e., a relational database structure) and are accessed/modified by a processor (similar to the processor 112 in FIG. 1) based on user input and/or commands from a team manager software application (described in further detail with respect to FIG. 3 below).

The player data structure 210, representing the players 1-N in the sports league (e.g., Kobe Bryant, Lebron James, Kevin Durant for the example of an NBA-based league; Russell Wilson, Michael Crabtree, Montee Ball for the example of an NFL-based league; Matt Kemp, Albert Pujols, Prince Fielder for the example of a Major League Baseball-based league), contains data relating to each specific player. The data will generally include general information about the player (e.g., name, height, weight, which team the player plays for, the player's position, the player's injury status, which days the player is playing, etc.), as well as past and current statistics data for the player, which may be retrieved over a network from a live statistics feed. The statistics data will normally be unique to the professional sports league, or at least the sport, on which the fantasy sports league is based. Thus, in a league based on the NBA, statistics such as points scored, field goal percentage, rebounds, blocks, steals, etc. would normally be captured for a particular player. The data may also include the player's projected future performance, as indicated by the player's rank, and an add/drop indicator, all of which may be generated by a team manager software application based on input from server-side administrators and the past/current statistics for the player (described in further detail below with respect to FIG. 3).

The server-side administrators referred to herein are not limited solely to the sense of information technology workers. Rather, such server-side administrators would also include experts in the particular fantasy sport, as some human judgment may be exercised in projecting future performance of any player, based on match-ups, trends, and other parameters.

The user team data structure 220, representing the user teams 1-N, contains data relating to each specific user fantasy team registered to participate one of the various fantasy sports leagues on the fantasy sports web site. The data will generally include general attribute data about the user, such as age, team name, login credentials, preferences, league identification corresponding to the league in which the user team is participating, etc., as well as roster and/or player data including, but not limited to, the user team's current roster of players, the user's line-up for a given day, etc. The drafting and management commands sent by the league operation software application (or program) to the processor modifies the data in the database 200 to maintain the rosters and related information for user-managed fantasy teams, such as that found on user team data structure 220. For example, the league operation software application (or program) may have a user team creation means that allows a user to create a team by selecting players and, thereafter, allows the user to manage his or her team such as by setting a line-up of players.

The computer team data structure 230, representing the computer teams 1-N, contains data relating to each specific computer team 1-N managed by a team manager program. The data will generally include general attribute data about the computer team, such as the team name, a league identification corresponding to the league the computer team is competing in, etc., as well as roster and/or player data including, but not limited to, the computer team's current roster of players, the computer team's line-up for a given day, etc. A roster generally being a subset of players from a larger set of players in a sports league.

The league data structure 240, representing the plurality of leagues 1-N, contains data relating to each specific fantasy sports league in the fantasy sports web site. The data will generally include general information about each league such as the league identification number, the league name, league membership (e.g., which teams are in the league, etc.), draft data (e.g. date/time of the draft, the draft order, etc.), the scoring parameters (e.g. value assigned to a statistical category, etc.), roster parameters (e.g. total number of players per roster, minimum and maximum number of players allowed per position, minimum number of players allowed to be started per position, etc.) other league rules (e.g. waiver rules, trading rules, etc.), waiver data, free agent data, and other information pertinent to the operation of the league. Each league 1-N includes at least two user teams and at least one computer team. For example, a given league may include two user teams and eight computer teams to form a ten team fantasy league. The teams may for example compete against each other on a weekly basis (in head-to-head type leagues) or against all other teams throughout the whole season (in rotisserie type leagues). The user teams may also compete against other user teams in other leagues to determine which user team is performing the best on the fantasy sports web site.

For efficiency, the data structures 210-240 in FIG. 2 will be linked together in some way to efficiently organize the data in a fantasy sports system. Take a given League N for example. The data stored in the league data structure 240 may indicate that League N contains eight teams: user teams 1-3 and computer teams 4-8. Instead of storing the data associated with each team within the league data structure 240 for the League N, the league data structure 240 may include a link to the user teams 1-3 and computer teams 4-8 in the user team data structure 220 and the computer team data structure 230, respectively. Similarly, for the real-world players on the roster of each user team 1-3 and computer team 4-8, the user team data structure 220 and the computer team data structure 230, respectively, may include links to the corresponding real-world players in the player data structure 210. A processor may therefore efficiently access league/team/player data in response to a user input or command from a team manager program. Of course, a processor may directly access each data structure as required by the system. Moreover, in this manner, a processor may modify player data, such as ranking data, activating an add/drop indicator, bench/start indicator, etc., to manage the computer teams 1-N during competition.

FIG. 3 is a detailed block diagram of an example of a computer team manager software application (or program) 300 implemented in the fantasy sports system (similar to system 100 of FIG. 1) according to an embodiment of the present invention. As shown in FIG. 3, the computer team manager software application 300 includes a data receiver 310, a global manager 320, a player rankings manager 330, a draft manager 340, an add/drop manager 350, and a line-up manager 360, all of which communicate with each other as shown in FIG. 3. The computer team manager software application 300 governs the play of all server-managed teams (or computer teams) that are competing in the various leagues of the fantasy sports system, described in FIG. 1, based on data received from a database (similar to the database 200 of FIG. 2) and input from server-side administrators. The computer team manager software application 300 modifies existing data in the database and/or stores new data in the data structures in the database to control the server-managed teams (described in further detail below).

The data receiver 310 shown in FIG. 3 receives data stored in a database (similar to the database 200 of FIG. 2) such as past performance data, for example statistics from last season, and current season statistics for players, player news, injury reports, etc. The data is used by the computer team manager program 300 to control the play of the server-managed teams. The data may be accessed by the player rankings manager 330, the draft manager 340, the add/drop manager 350, and the line-up manager 360, or other modules to be developed in the future.

The global manager 320 will generally receive commands/instructions from the player ranking manager 330, the draft manager 340, the add/drop manager 350, and the line-up manager 360 (described in further detail below with respect to each manager 330-360) and pass along the commands/instructions, such as drafting and management commands, to a CPU or other processor (similar to processor 112 of FIG. 1), which then modifies data in the database to manage the computer teams in the various fantasy leagues. For example, the player rankings manager 330 may provide a ranking for each real-world player, and the global manager 320 may instruct the processor to modify the player data in the database (similar to player data structure 210 in FIG. 2), so that an associated rank may be arrived at for each player. The rank assigned to a particular player may affect that player's draft position, roster priority, free agency priority, etc.

The player rankings manager 330 may rank players based on projected future performance of that player, which may be generated using past season and current season performance data (such as points per game, rebounds per game, steals per game, free-throw percentage, etc., in a fantasy league based on the NBA) and input from server-side administrators. As described above, the player rankings manager 330 may provide the player rankings to the global manager 320, which may instruct the processor to modify the player data in the database on that basis. The player rankings may be used by the draft manager 340, the add/drop manager 350, and the line-up manager 360. The player rankings may be made available to users that subscribe to the fantasy sports web site, depending upon, among other factors, the preferences of the server-side administrators.

The draft manager 340 will generally govern the drafting strategy of all the server-managed teams in the fantasy sports system based on statistics data, for example the player ranks assigned by the player rankings manager 330, and drafting parameters (which take the rankings into account) including those defined by server-side administrators and send drafting commands to the global manager 320 of the computer team manager software application (or program) 300 for execution thereof. The drafting parameters will generally include a set of drafting rules to ensure that each computer team's roster is balanced. For example, in a rotisserie-type league, the teams that consistently perform well in a majority of the statistical categories (such as points, rebound, steals, etc.) usually win. Therefore, so as to make a game fair, the draft parameters will ensure that the computer teams do not draft one-dimensional teams (e.g., a team that has NBA players that score a lot of points, but do not rebound, steal, or have great field-goal percentages).

In one embodiment, the draft manager 340 may include a selection means for creating a computer team by selecting players based upon the drafting parameters and the previous statistics or performance for the pool of available players.

Moreover, the draft manager may assign “do not draft” values for specific players in the player data structure, so as to ensure they are not drafted too early in the fantasy draft. For example, say the server-side administrators determine that a certain player, say a rookie, is being drafted in the tenth round (on average) and the player's rank indicates that the player should be drafted in the sixth round. The draft manager may prevent computer teams from drafting the player in the sixth round because the player will likely be available in later rounds (say the eighth round). The draft manager 340 will generally also ensure that the computer teams draft enough players for each position (point guards, shooting guards, small forwards, etc.) as well as back-up players for each position.

The add/drop manager 350 governs the add/drop strategy of all the server-managed teams in the fantasy sports system based on the player ranks assigned by the player rankings manager 330 and a set of add/drop parameters (which take the rankings into account) defined by server-side administrators. The add/drop parameters may assign add/drop indicators for certain real-world players in the fantasy sports system. For example, if a player is injured, the server-side administrators would modify the add/drop parameters to assign a “drop indicator” to a given player in a player data structure. In this manner, the add/drop manager 350 would send the “drop indicator” data to the global manager 320, which would in turn instruct the processor to modify the player data to associate a “drop indicator” with that player. Consequently, each computer team that has that player would subsequently drop that player from their roster and pick up the next most highly ranked player of the same position. In a similar fashion, if a given player is performing well and that player is a free agent in many of the fantasy sports leagues, the add/drop manager would control teams to add that player to their roster and drop a player of the same position with a lower rank. In some embodiments of the present invention, the add/drop parameters control computer teams to act like human teams. For example, if a given computer team has no chance of winning, it could be controlled to be less aggressive on the waiver wire and play out the season with its current roster. Alternatively, if a given computer team has a strong chance of winning, it may be controlled to be more aggressive on the waiver wire (more frequent add/drops).

The line-up manager 360 governs the line-up strategy of all the server-managed teams in the fantasy sports system based on the player ranks assigned by the rankings manager 330 and line-up parameters (which take the rankings into account) defined by server-side administrators. The line-up parameters include a set of rules that determine how each server-managed team sets up its line-up on a daily basis throughout the course of the applicable season. The line-up manager 360 uses the logic defined by the line-up parameters to transmit commands to the global manager 320. The global manager 320 then instructs the processor to modify roster data for each team in the computer team database based on the line-up parameters. For example, the computer teams may be controlled to start the highest rated players at each position every day or start players that have the most games remaining. The parameters may be specific to the particular type that a league is. For example, in a rotisserie-type NBA fantasy sports league, the line-up manager 360 may control the computer teams to start (or bench) a “special player list” if there are less (or more) than X eligible starters available on a given computer team's roster. The line-up manager 360 may automatically set the line-ups for each computer team daily (at a specified time) or the server-side administrators may override and manually control the line-up manager 360 to set computer team line-ups as desired. The line-up manager may also be configured to set the line-ups for user teams in some cases. For example, if a user is unable to set the line-up for his/her fantasy team(s), he/she may authorize the line-up manager 360 to set his/her line-up automatically.

In one embodiment, computer team manager software application (or program) 300 includes a managing means that selects players not on the computer team and dropping players on the computer team based at least on the scoring parameters and performance of the players, e.g. add/drop manager 350 and determines a line-up of players from the players on the computer team based upon the roster and scoring parameters and performance of the players, e.g. line-up manager 360.

In another embodiment of the present invention, computer team manager software application (or program) 300 can include a trade manager. For example, a user may propose a trade to one of the computer teams. The computer team manager software application (or program) 300 could compare the player or players being offered to the player requested by the user from the computer team to determine if the trade should be made. The comparison could be determined based upon the player's rank or projected future performance. For example, the rank of the players being offered by the user could be summed and compared to the sum of the rank for the players being requested. If the sum of the players being requested is a selected percentage over the sum of the players being offered, e.g. 10%, the trade manager makes the trade and instructs the processor to modify roster data for each team involved in the trade in the database 200. By way of another example, the comparison could be based on predetermined preferences, such as by weighing the difference between the offered and requested players by position or statistical category.

According to one embodiment of the present invention, the computer team manager program 300 may allow server-side administrators to manually override any single computer team to manage that team directly. In such embodiments, the administrators may not want a given action (such as dropping/adding a player) to occur for all of the server-managed teams.

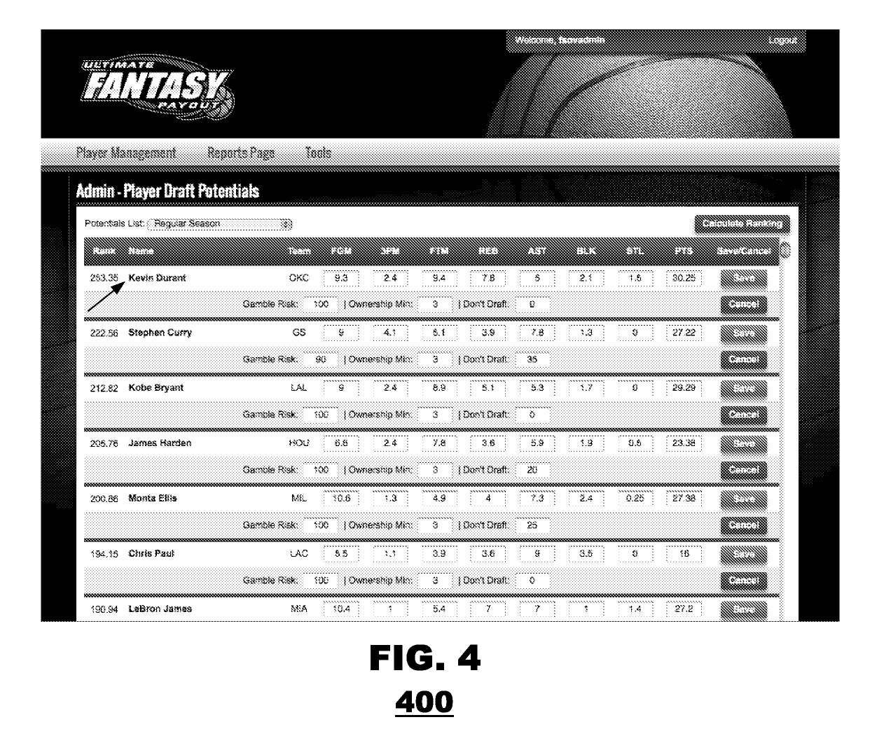

FIGS. 4-8 are a series screenshots of graphical user interfaces (GUIs) for the various aspects of the computer team manager program 300 of FIG. 3. The web pages may be accessed by server-side administrators to facilitate the functionality of the player rankings manager 330, the draft manager 340, the add/drop manager 350, the line-up manager 360, and the global manager 320. The data receiver 310 may receive data stored in a database (similar to database 200) to be accessed by the managers 330-360 (and used in their respective sets of parameters) and displayed on the web pages shown in FIGS. 4-8 for server-side administrators to analyze. FIGS. 4-8 will now be discussed in conjunction with the computer team manager program 300 of FIG. 3 and the server database 200 of FIG. 2 to describe the operation of a fantasy sports system according to embodiments of the present invention.

FIG. 4 is a screenshot of a player ranking manager web page 400, part of the player ranking manager 330 of FIG. 3, according to an embodiment of the present invention. The player ranking manager web page 400 may be one page of a fantasy sports web site hosted by a fantasy sports server (which may be similar to the fantasy sports server 110 of FIG. 1). The web page 400 will generally be accessed by server-side administrators by logging into the web site as an administrator and navigating to the player ranking manager web page 400. The administrators may utilize the player ranking manager web page 400 to modify player potential values for each real-world player in a fantasy sports server. As described above, the player potential values are generally based on past season and current season player performance. But they may also be based on the subjective opinion of the server-side administrators (who may be fantasy sports experts). The player ranking manager would calculate a numerical rank for each player in the applicable real-world sports league based on the projected future performance (or potentials) of each player, given the statistics data for that particular player, and also possibly based on the judgment of the server-side administrators. The player ranking and the projected future performance for each player may be transmitted to the global manager 320 of FIG. 3, which may instruct a processor (similar to processor 112 of FIG. 1) to modify the player data structure 210 in the server database 200 of FIG. 2 to assign the player rankings/projections to each player in the data structure.

For example, as shown on the player ranking manager web page 400, based upon past season and current season statistics and the judgment of the server-side administrators, Kevin Durant may be projected to average 30.25 points per game, 9.3 field goals per game, 7.8 rebounds per game, 2.4 turnovers per game, 5 assists per game, and 9.4 free-throws per game throughout the course of the NBA regular season (which spans 82 games, barring a lock-out). Based on the foregoing projections, Kevin Durant may be given a rank of 253.35, which may make him the most valuable fantasy NBA player in the fantasy sports system. The rankings will generally be utilized during regular season, by the add/drop manager 350 and the line-up manager 360 of FIG. 3, and/or during the fantasy draft, by the draft manager 340 of FIG. 3.

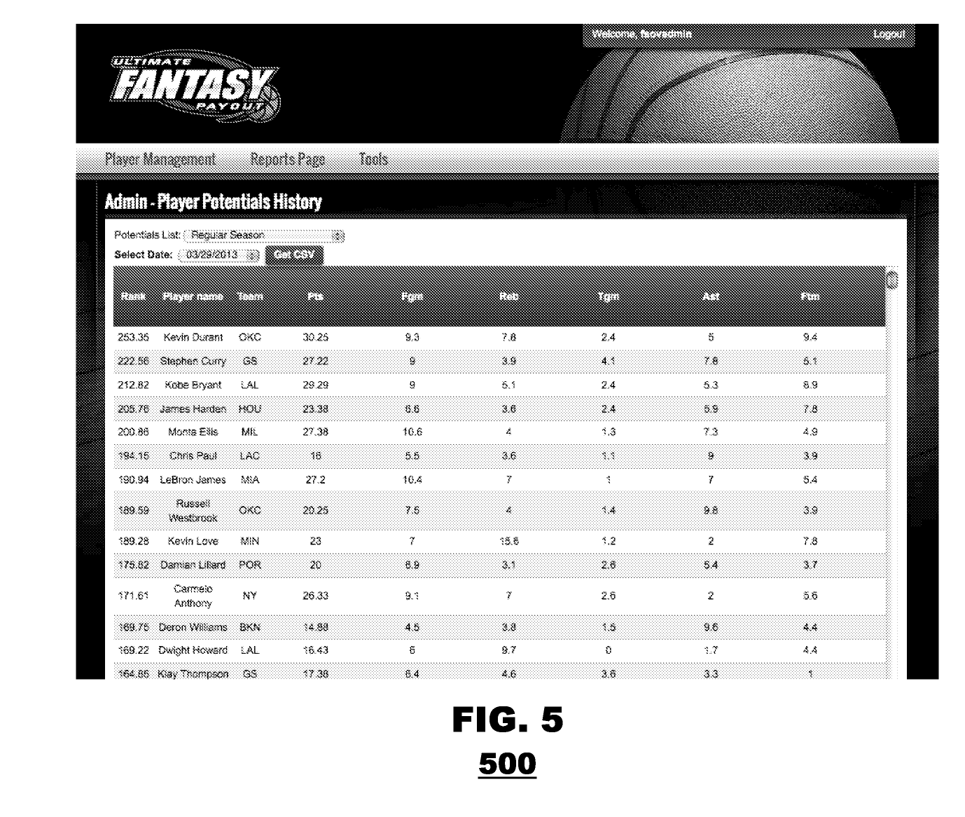

FIG. 5 is a screenshot of a player ranking history web page 500 according to an embodiment of the present invention. The player ranking history web page 500 is used by server-side administrators to review past player rankings, which may vary during the course of an NBA season. Such information is useful for determining future rankings or analyzing how accurate the rankings have been in the past. The historical player potential value data may enable the server-side administrators to more accurately project player performances as the NBA season progresses.

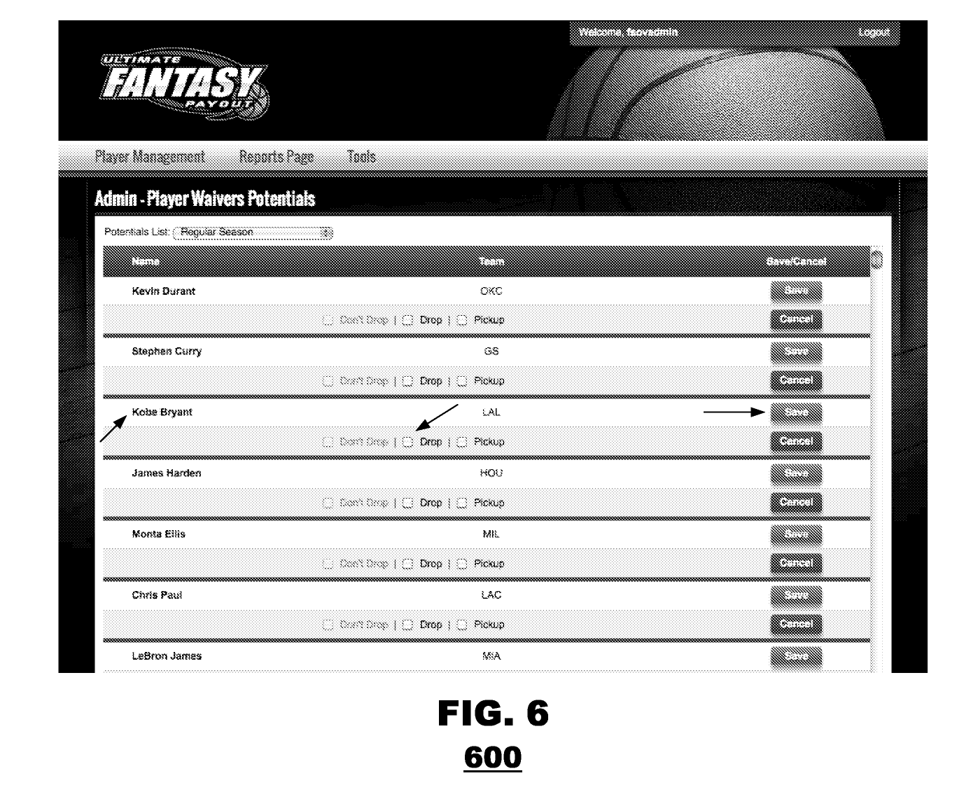

FIG. 6 is a screenshot of an add/drop manager web page 600, part of the add/drop manager 350 of FIG. 3, according to an embodiment of the present invention. Here again, the add/drop manager web page 600 is just one page in a fantasy sports web site hosted by a fantasy sports server (similar in operation to the fantasy sports server 110 of FIG. 1). The add/drop manager web page 600 is accessed by server-side administrators to facilitate the setting of add/drop indicators for specific players.

For example, say the server-side administrators want all server-managed teams to drop Kobe Bryant (which is very unlikely, unless he has a season ending injury). A given administrator would click the box labeled “Drop” associated with Kobe Bryant and click the “Save” button. Once the “Save” button is clicked, the global manager 320 of FIG. 3 instructs a processor (similar to processor 112 of FIG. 1) to modify the player data structure 210 in database 200 of FIG. 2 to associate a “drop indicator” with the player record for Kobe Bryant. Subsequently, the processor 112 analyzes the data associated with each computer team in the computer team data structure 230 in FIG. 2. If a given computer team's roster includes a link to the NBA player Kobe Bryant in the player data structure 210 of FIG. 2, the processor removes Kobe Bryant from the computer team's roster (i.e., drops him) in response to the “drop indicator” associated with Kobe Bryant. In this manner, for the various fantasy sports leagues hosted by the fantasy sports web site, each computer team is controlled to drop Kobe Bryant from their roster. “Add indicators” could operate in a similar fashion.

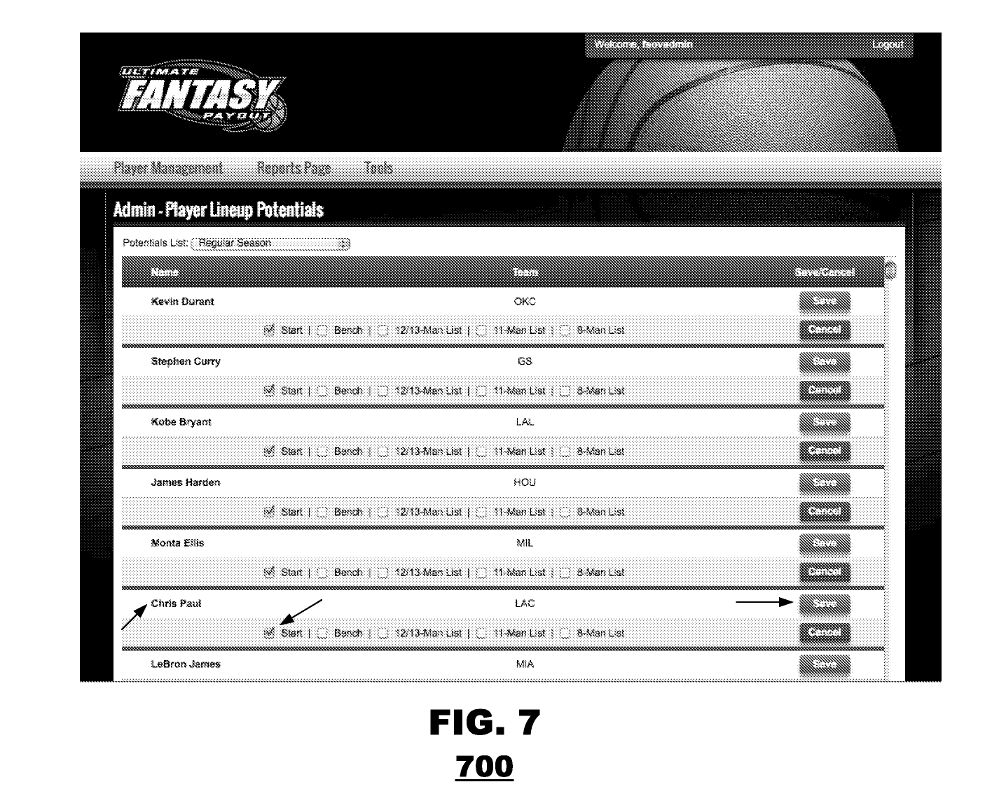

FIG. 7 is a screenshot of a line-up manager web page 700, part of the starting line-up manager 360 of FIG. 3 according to an embodiment of the present invention. The line-up web page 700 constitutes one page in a fantasy sports web site hosted by a fantasy sports server (similar to the fantasy sports server 110 of FIG. 1). The line-up manager web page 700 is accessed by server-side administrators to facilitate the management of the rosters of server-managed teams in the various leagues of the fantasy sports web site.

For example, say the server-side administrators want to ensure that, when Chris Paul is playing a game on a given day during the NBA season, he is in the starting line up all of the computer teams that have him on their roster. A given administrator would click the box labeled “Start” associated with Chris Paul and click the “Save” button. Once the “Save” button is clicked, the global manager 320 of FIG. 3 would instruct a processor (similar to processor 112 of FIG. 1) to modify the player data structure 210 in the server database 200 of FIG. 2 to associate a “start flag” with the player record for Chris Paul. Subsequently, the processor would analyze the data associated with each computer team in the computer team data structure 230 in the server database 200 of FIG. 2. If a given computer team's roster includes a link to the NBA player Chris Paul in the player data structure 210 of FIG. 2, the processor 112 would modify the roster data of each computer team in the computer team data structure 230 of FIG. 2 to ensure that Chris Paul is in the starting line-up every time he plays a game. In this manner, for the various fantasy sports leagues hosted by the fantasy sports web site, each computer team would be controlled to start Chris Paul when he is playing. In other words, by modifying the roster data in the computer team data structure 230 to start Chris Paul in every game he plays, each computer team in each league is managed to start Chris Paul because the league data structure 240 is linked to the computer team data structure 230. Since one would not want to start Chris Paul ahead of a higher rated player, such as LeBron James, the software would prevent that from happening. The user-managed teams would not be affected in these circumstances, because the user team data structure 220 would not be affected. Thus, user-managed teams that have Chris Paul would start/sit him based on the desires of the users managing the teams.

According to embodiments of the present invention, the server side-administrators also indicates whether certain players should start on computer teams of various sizes by clicking the “12/13-Man List,” “11-Man List,” or “8-Man List” boxes. For example, the administrators would check the “11-Man List” box, along with the “Start” box, associated with Chris Paul to ensure that he may start for each computer team that may have a roster size of eleven.

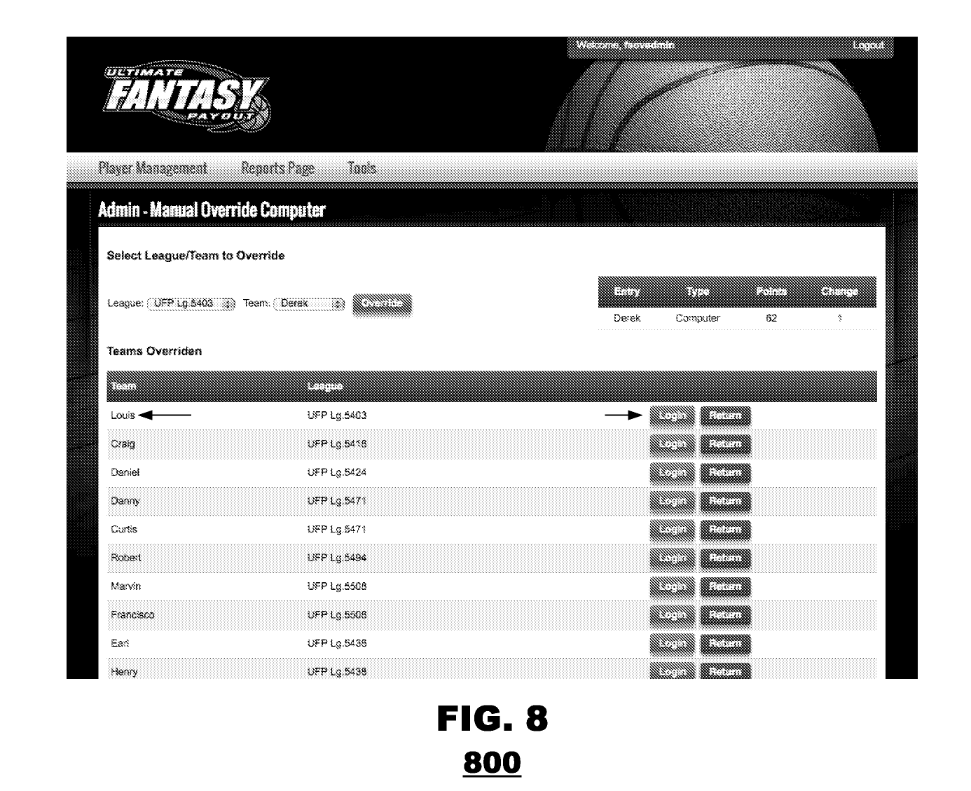

FIG. 8 is a screenshot of a manual override web page 800 according to embodiments of the present invention. The manual override web page 800 is one page in a fantasy sports web site hosted by a fantasy sports server (similar to the fantasy sports server 110 of FIG. 1). The manual override web page 800 would be accessed by a server-side administrator to facilitate the manual control of a given computer team in the computer team data structure 230 in database 200 of FIG. 2. In other words, the manual override web page 800 allows an administrator to modify roster data (line-up, add/drop, etc.) for a given computer team. For example, say an administrator would like to manually set a starting line-up of a computer team named “Louis.” The administrator would click the “Login” button and enter his/her credentials to manually set the starting line-up of the Louis computer team. In such circumstances, the administrator may want to ensure that the remaining computer team rosters are not modified in the same manner as the Louis team's roster is modified.

In another embodiment of the present invention, management of a user created team could be replaced with management by the computer team manager software application 300 described above. If a user in a fantasy league, wherein all of the teams are user teams, loses interest, such as if the user's team is not doing well or if the user is too busy, and stops managing his or her team, the team could be managed in accordance with the computer team manager software application 300. For example, a league commissioner could contact the fantasy league provider and identify a team for which the user of that team is no longer actively participating by setting line-ups. The fantasy league provider could then switch management of that team over to the computer team manager software application 300 so that the computer team manager application would manage the team as if it had drafted the team from the start. The computer team manager software application 300 could optionally include a mechanism that allows the user to regain management responsibilities should he or she regain interest in participating. Optional safeguards could also be implemented to prevent unwanted transfer of management to the computer team manager software application 300, such as by sending an email to the user of the team which requires a response within a certain amount of time from receipt of the email. Alternatively, the remaining users in the league could take a vote to change the management of that team. An feature could also be offered wherein a user could see what the computer team manager software application 300 would do to the user's team if the computer team manager software application 300 was running the user's team so as to provide ideas to the user to manage the team.

Embodiments of the present invention may provide several benefits over typical fantasy sports web sites. The present invention allows users to compete with a computer managed team(s) reflecting the knowledge of fantasy sports experts while also competing against other users that may be their friends. Competing in a fantasy sports league that only includes user-managed teams has several disadvantages. For example, the competition level against users varies significantly. Moreover, some users lose interest if their teams are not doing well or if they are too busy. In such circumstances, the league may lose its competitive nature and none of the users may be motivated to pay attention to their respective teams. On the other end of the spectrum, competing in a fantasy sports league that only includes computer-managed teams may also have its disadvantages. Some fantasy sports users enjoy competing in fantasy sports against other users that may or may not be their friends. Such users could lose interest if they are competing against only computer-managed teams. Moreover, fantasy sports leagues have message boards where players can engage in competitive banter, which is appealing to many users. This aspect of fantasy sports leagues would not be present in leagues where one user competes only against a set of computer teams.

Moreover, leagues may be easier to form according to embodiments of the present invention. For example, if a group of four fantasy sports users would like to create a league and could not find other users to join their league, the present invention permits them to fill the remaining spots in their league with computer teams. In such circumstances, instead of finding random users that may not take fantasy sports as seriously, or may be at an elevated level compared to the original group of users, the users will be able fill the remaining spots with computer teams which will always provide adequate competition.

Although the present invention is described above with respect to the NBA, the same principles apply to any fantasy sports game, contest, league or web site. There may be different configurations and permutations associated with fantasy sports web site based on other sports, but the same underlying principles and techniques describe above are applicable to other types of fantasy sports leagues.

Moreover, although the foregoing techniques have been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. Those skilled in the art will appreciate that these techniques may be implemented in other ways without departing from the spirit and substantive features of the invention. The present embodiments are therefore to be considered in all respects as illustrative and not restrictive.

1. A computer system, comprising:
a data storage medium for storing information thereon;
a database stored on the data storage medium, the database including data structures representing:
a plurality of players in a sports league and corresponding statistics and management data for each of the plurality of players;
a plurality of computer- and subscriber-managed fantasy sports teams and corresponding roster and attribute data for each of the fantasy sports teams; and
a plurality of fantasy sports leagues, each of the plurality of fantasy sports leagues comprising a plurality of fantasy sports teams, at least one of the plurality of fantasy sports teams being a computer-managed fantasy sports team and at least two other of the plurality of fantasy sports teams being subscriber-managed fantasy sports teams;
a processor;
a league operation software application to operate the processor so as to operate the fantasy sports leagues; and
a computer team manager software application to operate the processor to:
draft players for each of the computer-managed fantasy sports teams among the plurality of fantasy sports leagues according to the statistics and management data;
manage each of the computer-managed fantasy sports teams within the plurality of fantasy sports leagues according to the statistics and management data; and
compete each of the computer-managed fantasy sports teams with the subscriber-managed fantasy sports teams according to rules in the respective leagues.

2. The computer system of claim 1, wherein the statistics data comprises past performance data of the plurality of players in the plurality of fantasy sports leagues.

3. The computer system of claim 1, wherein the management data comprises draft parameters; indications for adding, dropping, starting and benching select ones of the plurality of players; and a ranking for each of the plurality of players.

4. The computer system of claim 1, wherein the computer team manager software application sends drafting and management commands to the processor according to the statistics and management data.

5. The computer system of claim 4, wherein the computer team manager software application can be manually overridden by an administrator to send management commands to the processor.

6. The computer system of claim 4, wherein the computer team manager software application is configured to:
determine the drafting commands according to a drafting manager based on the statistics data and management data; and
determine the management commands according to instructions from an add/drop manager and a line-up manager, which are based on the statistics data and management data.

7. A fantasy sports system, comprising:
a data structure representing at least one fantasy sports league comprising links to data representing a set of at least one computer-managed team and at least two user-managed teams, each of the at least one computer-managed team and at least two user-managed teams comprising a roster of real-world athletes in a real-world sports league; and
a server to control the at least one computer-managed team to draft real-world athletes and manage the roster of the at least one computer-managed team based on statistics and management data associated with each of the real-world athletes.

8. The fantasy sports system of claim 7, wherein the statistics data comprises past performance data of the real-world athletes in the fantasy sports league.

9. The fantasy sports system of claim 7, wherein the management data comprises draft parameters; indications for adding, dropping, starting and benching select ones of the plurality of players; and a ranking for each of the real-world athletes.

10. The fantasy sports system of claim 7, wherein the server can be manually overridden by an administrator to control the at least one computer-managed team.

11. The fantasy sports system of claim 7, wherein the server is configured to:
draft real-world athletes according to a drafting manager based on the statistics data and management data; and
manage the at least one computer-managed team according to instructions from an add/drop manager and a line-up manager, which are based on the statistics data and management data.

12. A fantasy sports server, comprising:
a data storage medium for storing information therein;
a database stored in the data storage medium, the database including data structures representing:
a plurality of players in a sports league and corresponding statistics and management data for each of the plurality of player;
a plurality of computer- and subscriber-managed fantasy sports teams and corresponding roster and attribute data for each of the plurality of fantasy sports teams; and
a plurality of fantasy sports leagues, each of the plurality of fantasy sports leagues comprising a plurality of fantasy sports teams, at least one of the plurality of fantasy sports teams being a computer-managed fantasy sports team and at least two other of the plurality of fantasy sports teams being subscriber-managed fantasy sports teams;
a processor;
a computer team manager program to:
transmit drafting and management commands according to the statistics and management data;
manage the at least one computer-managed fantasy sports team to compete against the subscriber-managed fantasy sports teams in response to the drafting and management commands; and
modify data in the database to maintain a roster for the at least one computer-managed fantasy sports team and related information; and
a league operation program to:
receive the drafting and management commands from subscribers;
modify data in the database to maintain rosters for the subscriber-managed fantasy sports teams and related information; and
control operation of the plurality of fantasy sports leagues.

13. The fantasy sports server of claim 12, wherein the statistics data comprises past performance data of the plurality of players in the plurality of fantasy sports leagues.

14. The fantasy sports server of claim 12, wherein the management data comprises draft parameters; indications for adding, dropping, starting and benching select ones of the plurality of players; and a ranking for each of the plurality of players.

15. The fantasy sports server of claim 12, wherein the computer team manager program can be manually overridden by an administrator to send management commands to the processor.

16. The fantasy sports server of claim 12, wherein the computer team manager program is configured to:
determine the drafting commands according to a drafting manager based on the statistics data and management data; and
determine the management commands according to instructions from an add/drop manager and a line-up manager, which are based on the statistics data and management data.

17. A method of operating a fantasy sports server, the server including a processor and a data storage medium, the method comprising:
storing a database on the data storage medium, the database including data structures representing:
a plurality of players in a sports league and corresponding statistics and management data for each of the plurality of players;
a plurality of computer- and subscriber-managed fantasy sports teams and corresponding roster and attribute data for each of the plurality of fantasy sports teams; and
a plurality of fantasy sports leagues, each of the plurality of fantasy sports leagues comprising a plurality of fantasy sports teams, at least one of the plurality of fantasy sports teams being a computer-managed fantasy sports team and at least two other of the plurality of fantasy sports teams being subscriber-managed fantasy sports teams;
providing a computer team manager software application for transmitting drafting and management commands according to the statistics and management data and managing the computer-managed fantasy sports teams to compete against the subscriber-managed fantasy sports teams in response to the drafting and management commands; and
providing a league operation software application to receive the drafting and management commands from subscribers, modifying data in the database to maintain rosters and related information for the at least two subscriber-managed fantasy sports teams, and controlling the operation of the plurality of fantasy sports leagues.

18. The method of claim 17, wherein the statistics data comprises past performance data of the plurality of players in the plurality of fantasy sports leagues.

19. The method of claim 17, further comprising providing an add/drop indicator, a start/bench indicator, or an overall ranking for each player.

20. The method of claim 17, further comprising manually overriding the computer team manager program to send management commands to the processor.

21. The method of claim 17, further comprising configuring the computer team manager program to:
determine the drafting commands according to a drafting manager based on the statistics data and management data; and
determine the management commands according to instructions from an add/drop manager and a line-up manager, which are based on the statistics data and management data.

22. The fantasy sports server of claim 17, further comprising drafting balanced rosters for the at least one computer-managed fantasy sports team.

23. The fantasy sports server of claim 17, further comprising setting a line-up for the at least one computer-managed fantasy sports team based on a ranking for each of the plurality of players on a roster of the at least one computer-managed fantasy sports team.

24. A fantasy sports system comprising:
a league with at least two user teams and at least one computer team;
a data base containing a set of parameters at least including drafting parameters, roster parameters and scoring parameters;
user team creation means for permitting each of the at least two user teams the capability of being created through selection of players and t managed by a user wherein being managed by a user includes determining a line-up of players from the selected players;
selection means for creating at least one computer team by selecting players based at least upon the set of parameters and previous performance of the players;
managing means for managing at least one computer team capable of:
selecting players not on the at least one computer team and dropping players on the at least one computer team based at least on the scoring parameters and performance of the players;
determining a line-up of players from the players on the at least one computer team based upon the roster and scoring parameters and performance of the players; and
scoring means for assigning values to each player from the line-up of players based upon the performance of the players from the line-up of players and the scoring parameters and for determining a relative performance of the at least two user teams and at least one computer team with respect to each other.

25. A fantasy sports system with a plurality of user teams forming a fantasy league with rules, wherein each of the plurality of user teams contains a roster, the roster having a subset of players from the set of players in a sports league comprising:
a computer team manager software application to manage one of the plurality of user teams by operating the processor to:
determine a line-up of select players from the managed one of the plurality of user teams roster;
remove players from the managed one of the plurality of user teams roster and add new players from the set of players in a sports league not then on the roster of any of the plurality of user teams;
modify projected future performance of each of the set of players in a sports league; and
compete the managed one of the plurality of user teams against the other of the plurality of user teams according to the rules in the fantasy league.
